(19) United States
(12) Patent Application Publication
(10) Pub. No.: US 2018/0326949 A1
(43) Pub. Date: Nov. 15, 2018

(54) DEVICE FOR LOCKING A WIPER BLADE TO A DRIVE ARM

(71) Applicant: Valeo Systèmes d'Essuyage, Le Mesnil Saint Denis (FR)

(72) Inventors: Julien Carrion, Issoire (FR); Laurent Andre-Masse, Issoire (FR); Geoffrey Bayard, Issoire (FR); Christophe Chassaing, Issoire (FR); Grégory Kolanowski, Issoire (FR); Chantal Marquet, Issoire (FR); Gilles Petitet, Issoire (FR)

(73) Assignee: Valeo Systèmes d'Essuyage, Le Mesnil Saint Denis (FR)

(21) Appl. No.: 15/774,792

(22) PCT Filed: Oct. 7, 2016
(86) PCT No.: PCT/EP2016/074064

§ 371 Date: May 9, 2018

(30) Foreign Application Priority Data
Nov. 9, 2015 (FR) 1560685

(51) Int. Cl. B60S 1/40; B60S 1/04

(52) U.S. Cl. CPC B60S 1/407; B60S 1/4048; B60S 1/0491

(57) ABSTRACT

Device for locking a windshield wiper (10) to a drive arm (12), characterized in that it comprises electrical means (4) able to drive a reversible movement of at least one locking element (5) secured to the arm (12) or to the wiper (10), said at least one locking element (5) moving relative to the arm (12) or to the wiper (10) to which it is secured between an unlocked position in which said at least one locking element (5) is secured only to the arm (12) or to the wiper (10) and a locked position in which said at least one element (5) is secured to the arm (12) and to the wiper (10).

The present invention concerns a device for locking a windshield wiper to a drive arm. It also consists in a windshield wiper provided with said device, as well as a method of locking the wiper to the arm.

A windshield wiper for glazing such as the windshield of a motor vehicle typically comprises a wiper blade, generally of rubber, intended to rub against the glazing of the vehicle to evacuate water and move it out of the field of view of the driver. The wiper further includes a longitudinal spine that stiffens the wiper blade so as to strengthen the application of that blade to the windshield, as well as a mount to support the spine and the blade. The wiper also includes a longitudinal cover member including an upper aerodynamic deflector intended to strengthen the pressing of the wiper onto the windshield and therefore to improve the aerodynamic performance of the system.

The wiper is attached to a drive arm effecting an angular to-and-fro movement by an assembly constituted of a mechanical connector and an adapter. The connector is a part that is fixed directly to the structure of the wiper, the adapter being an intermediate part that enables connection and securing of the connector to the drive arm. These two parts are generally connected to one another by a transverse pin that allows relative rotation thereof.

Assembling the wiper to the arm and disassembling it therefrom must be simple and relatively rapid, the assembly time generally not exceeding one minute. To prevent theft of the wiper when the latter is assembled to the arm, it is desirable to lock the arm-wiper assembly. For example, it may be wished to lock the arm-wiper connection when the driver is not present in the vehicle and/or when the ignition switch of the vehicle is not operated, and then to unlock the arm-wiper connection when the driver is in the vehicle and/or the ignition switch of the vehicle is operated.

The present invention makes it possible to achieve these objectives by proposing a reversible device for locking a windshield wiper to a drive arm.

The invention therefore consists in a device for locking a windshield wiper to a drive arm. The use of electricity to heat the wipers on some vehicles allows the application described in the context of the invention.

The device according to the invention comprises electrical means able to drive a reversible movement of at least one locking element secured to the arm or to the wiper, said at least one locking element moving relative to the arm or to the wiper to which it is secured between an unlocked position in which said at least one locking element is secured only to the arm or to the wiper and a locked position in which said at least one element is secured to the arm and to the wiper.

The use of a locking element movable between two specific positions, one in which it is secured to only one of the two parts (arm or wiper) and the other in which it is secured to the two parts (arm and wiper), enables reversible locking and unlocking of the arm-wiper assembly.

By “secured to the arm or the wiper” in the sense of the invention is meant that the locking element is in contact with the arm or the wiper, with the result that the locking element makes it possible in the locked position to block at least one degree of freedom of the arm relative to the wiper and/or of the wiper relative to the arm. In the locked position, the arm and the wiper are therefore mechanically connected via the locking element. Other locking means may add blocking of the degrees of freedom not blocked by the locking element in the locked position.

In a first embodiment, the electrical means are able to actuate in translation a piston, the movement of said piston driving movement of said at least one locking element.

Said piston may be the core of an electromagnet, said core being movable in translation by the magnetic field produced by the electromagnet.

Alternatively, said piston may be part of a device enabling movement of the piston by an electric current.

In the unlocked position said at least one locking element may be secured to a connector of the wiper and in the locked position said at least one locking element may be secured to the connector and to an end part of the arm.

In a first example of the first embodiment, said at least one locking element comprises at least one rod able to be engaged in the locking position in an opening of said end part and to be held at a distance from said opening in the unlocked position.

Said opening is advantageously circular.

Said at least one rod may be held in the unlocked position with the aid of a return element.

Said at least one rod may be movable in translation in a direction substantially orthogonal to the direction of movement of the piston.

Said at least one locking element may comprise two rods aligned substantially orthogonally to the direction of movement of the piston and movable by the piston in two opposite directions.

The piston may have a beveled end intended to be in contact with an end of said rods in the unlocked position.

In the locked position, the two rods are advantageously in contact with the piston.

In a second example of the first embodiment, said at least one locking element comprises a leaf spring of which at least one end is able to be engaged in an opening of the end part of the arm in the locked position.

Said spring may be disposed substantially transversely to the piston and is movable in translation with the aid of an actuator secured to the piston and mounted on at least one rail between a curved position of the spring forming the unlocked position, in which each end of the spring is at a distance from an opening of the end part, and a deployed position of the spring, forming the locked position, in which each end of the spring is engaged in an opening of the end part.

In a third example of the first embodiment, at least one locking element comprises a toothed shaft driven in rotation by a toothed part of the piston.

The toothed shaft may comprise two elongate ends each projecting from an elongate opening of the end part of the arm and movable by the rotation of the toothed shaft between an unlocked position in which the longitudinal axis of each elongate end of the shaft is substantially aligned with the longitudinal axis of each opening and a locked position in which the longitudinal axis of each end of the shaft is not aligned with the longitudinal axis of each opening, so that each end of the shaft bears on the end part of the arm.

In a fourth example of the first embodiment, the piston is secured to the arm and, the arm being able to be mounted on and demounted from an element secured to the wiper, in particular with the aid of a clip, the piston is movable between an unlocked position, in which unlocking is authorized, and a locked position, in which the piston forms a stop preventing demounting.

The clip may comprise a lug mounted on a removable platform, for example to be mounted on the arm via an opening of the arm in which the lug comes to be inserted by movement of the platform, and the platform may be provided with a housing to receive the piston placed under the lug, so that the piston forms a stop for the platform when it is engaged in said housing in the locked position.

The element secured to the wiper may be an adapter.

In a second embodiment, said at least one locking element comprises a bimetal strip.

The bimetal strip may be deformable by a variation of temperature, for example by heating, from a locked position in which it is secured to an end part of the arm and an adapter to an unlocked position in which it is secured only to the end part.

The electrical means may be able to heat the bimetal strip.

The electrical means may be able to heat the bimetal strip directly or able to heat the bimetal strip via a heating element disposed on the end part.

The invention also consists in a device for locking a windshield wiper to a drive arm, characterized in that locking is produced with the aid of magnetization means secured to the arm or to the wiper and cooperating with means able to be magnetized and secured to the wiper or to the arm, respectively, and in that the magnetization means or the means able to be magnetized are rotatably mounted in the arm or the wiper to which they are secured.

The invention also consists in a windshield wiper comprising a locking device as described above.

The invention also consists in a motor vehicle.

The motor vehicle according to the invention comprises a windshield wiper and a drive arm, a device for locking the wiper to the arm described above, and means for activation of the locking and means for detection of the presence of a driver in the vehicle and/or the operation of an ignition switch in the vehicle, the activation means being able to activate the locking in the event of detection by the detection means of the presence of a driver in the vehicle and/or of starting of the engine of the vehicle.

The invention finally consists in a method of locking a windshield wiper to a drive arm employing a device as described above.

The method may comprise a locking step comprising a movement of said at least one locking element between the unlocked position and the locked position.

The locking step may be executed in the event of detection of the presence of a driver in the vehicle and/or of starting of the engine of the vehicle.

The method may also comprise an unlocking step comprising a movement of said at least one locking element between the locked position and the unlocked position.

The invention will be better understood and other details, features and advantages of the invention will become apparent on reading the following description given by way of nonlimiting example and with reference to the appended drawings in which:

FIG. 1 is a perspective view of a windshield wiper connected to a wiper arm,

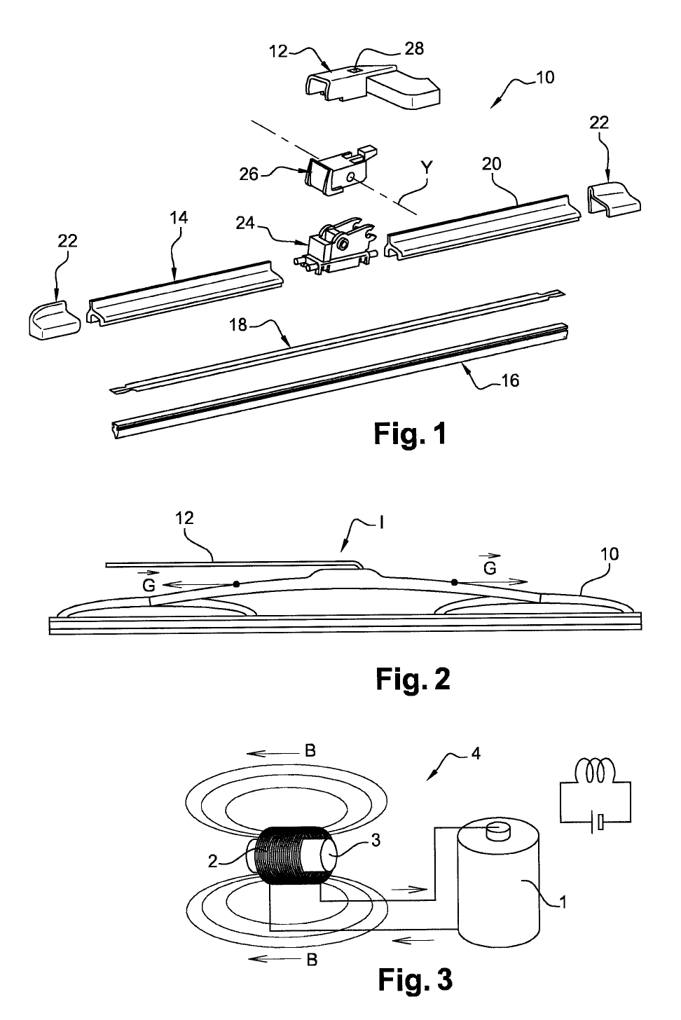

FIG. 2 is a diagrammatic view of windshield wiper,

FIG. 3 is a diagrammatic view of an electromagnet,

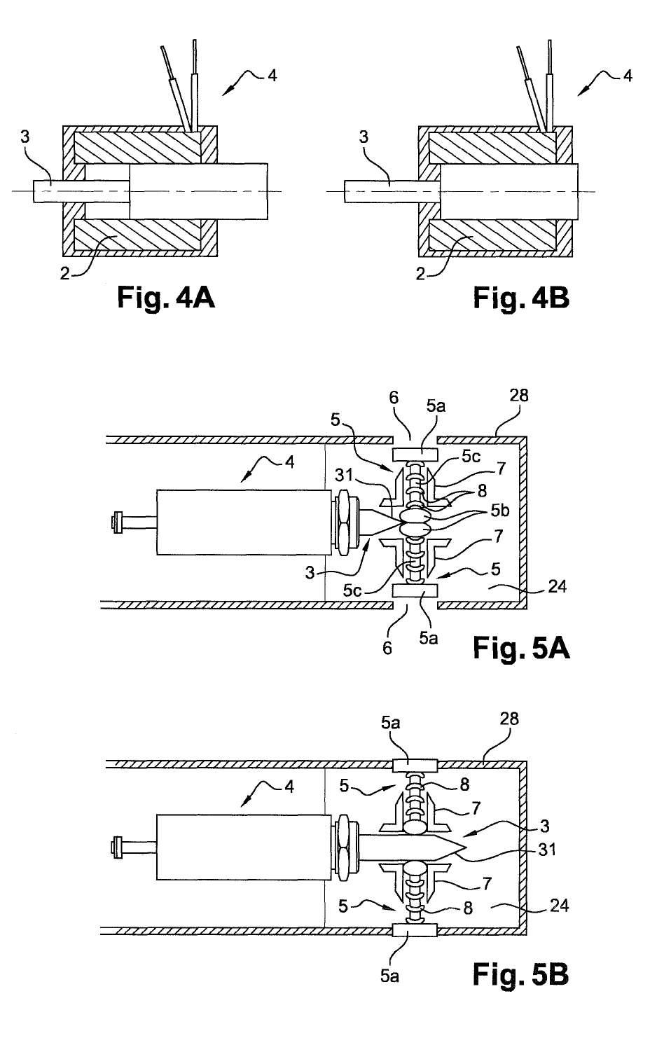

FIG. 4A is a view in partial longitudinal section of the electromagnet in a first position of the end of the core of the electromagnet,

FIG. 4B is a view in partial longitudinal section of the electromagnet in a second position of the end of the core of the electromagnet,

FIG. 5A shows diagrammatically an unlocked position of a locking device according to a first example of a first embodiment of the invention,

FIG. 5B shows diagrammatically a locked position of a locking device according to a first example of a first embodiment of the invention,

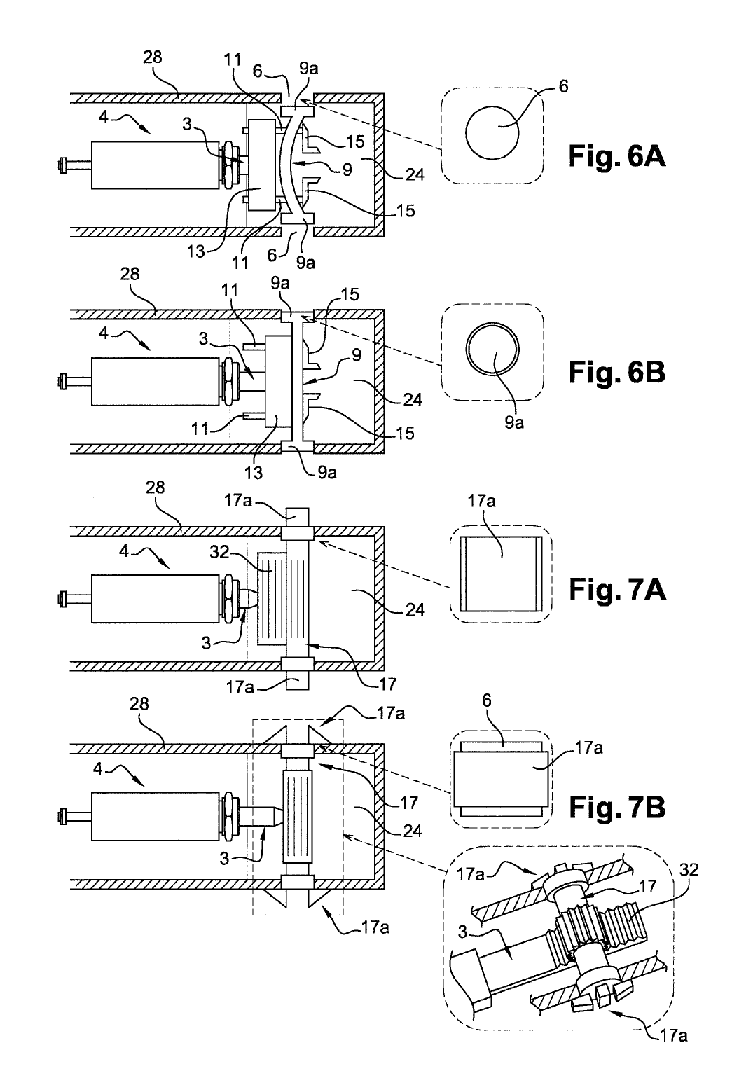

FIG. 6A shows diagrammatically an unlocked position of a locking device according to a second example of a first embodiment of the invention,

FIG. 6B shows diagrammatically a locked position of a locking device according to a second example of a first embodiment of the invention,

FIG. 7A shows diagrammatically an unlocked position of a locking device according to a third example of a first embodiment of the invention,

FIG. 7B shows diagrammatically a locked position of a locking device according to a third example of a first embodiment of the invention,

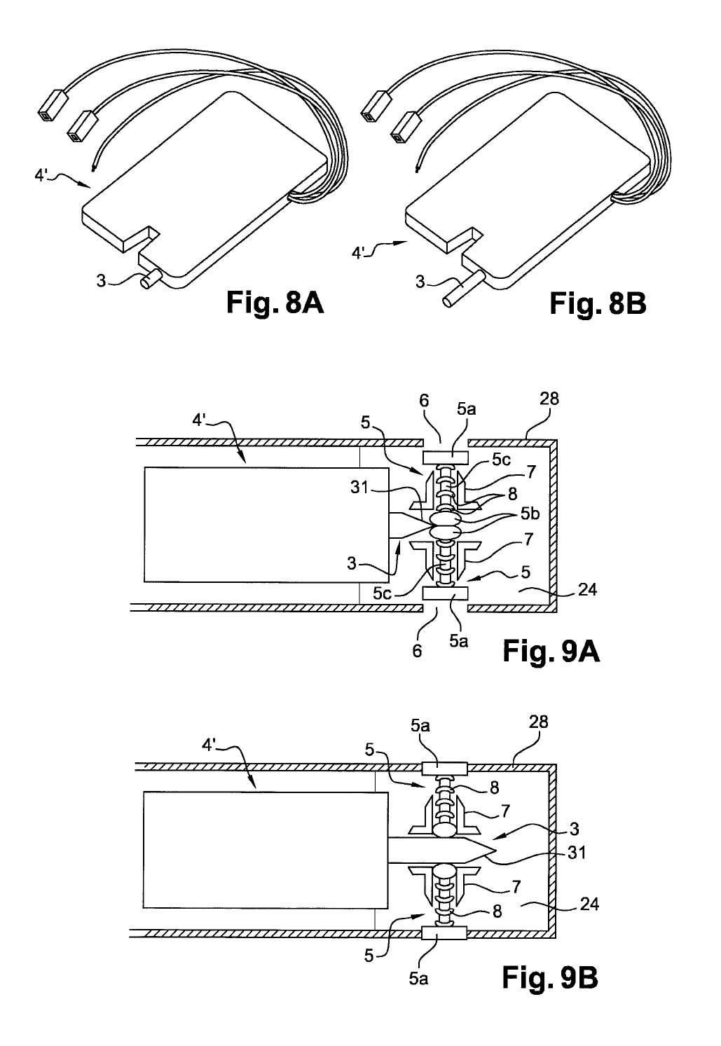

FIGS. 8A and 8B show an electromechanical card,

FIG. 9A shows diagrammatically an unlocked position of the locking device according to a variant of the first example of the first embodiment of the invention,

FIG. 9B shows diagrammatically a locked position of the locking device according to a variant of the first example of the first embodiment of the invention,

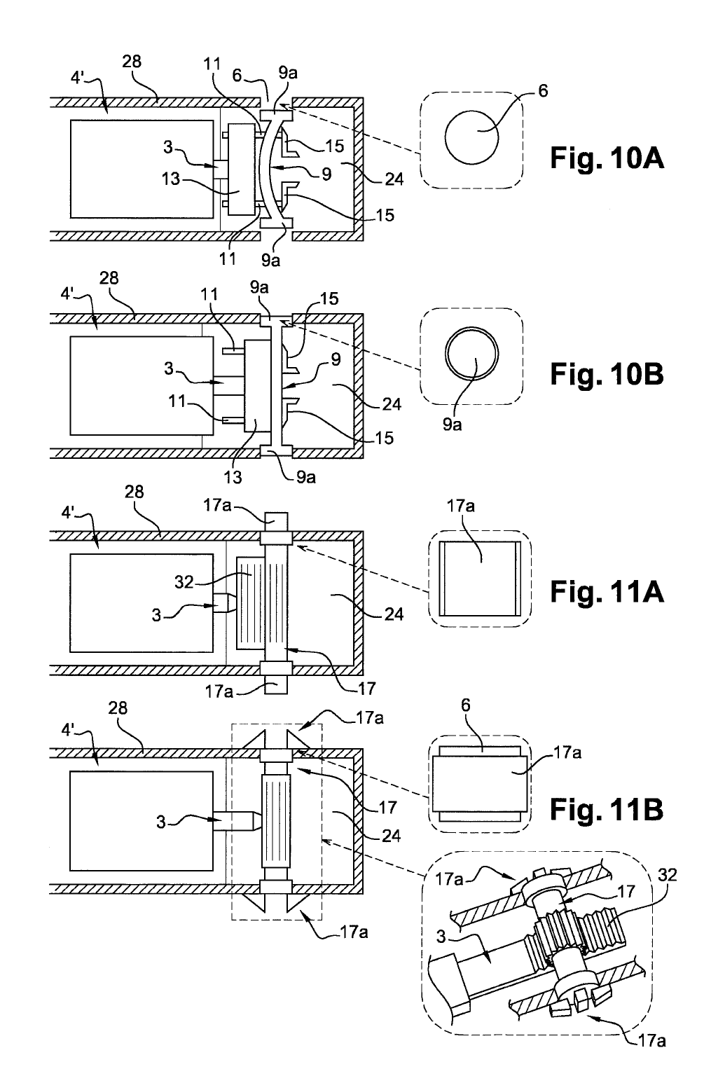

FIG. 10A shows diagrammatically an unlocked position of the locking device according to a variant of the second example of the first embodiment of the invention,

FIG. 10B shows diagrammatically a locked position of the locking device according to a variant of the second example of the first embodiment of the invention,

FIG. 11A shows diagrammatically an unlocked position of the locking device according to a variant of the third example of the first embodiment of the invention,

FIG. 11B shows diagrammatically a locked position of the locking device according to a variant of the third example of the first embodiment of the invention,

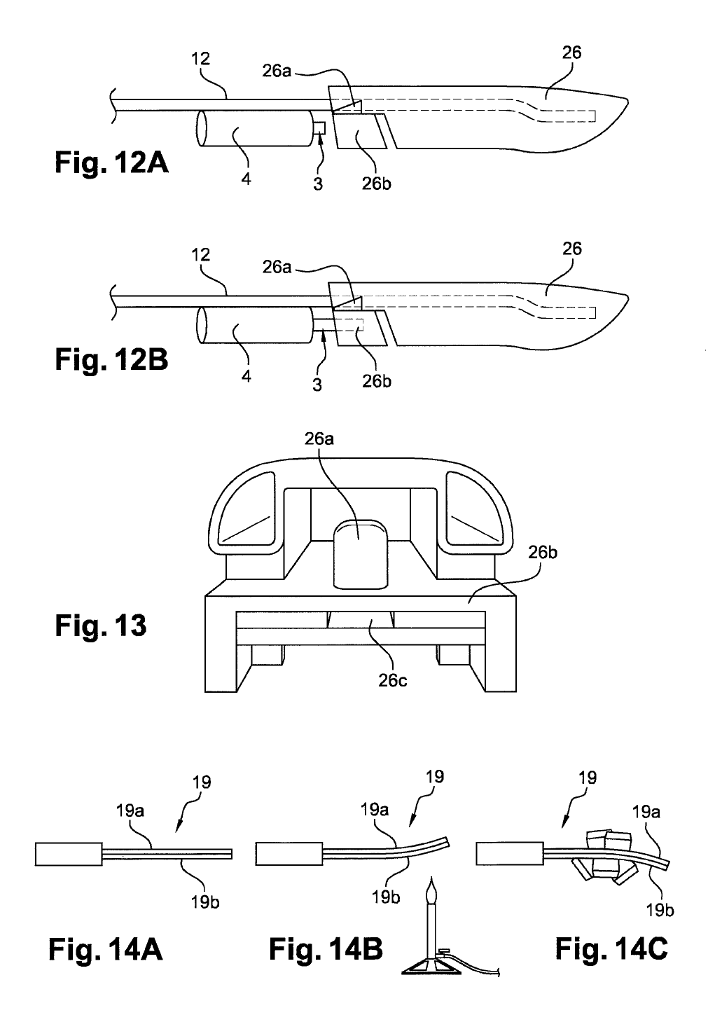

FIG. 12A shows diagrammatically an unlocked position of the locking device according to a variant of the fourth example of the first embodiment of the invention,

FIG. 12B shows diagrammatically a locked position of the locking device according to a variant of the fourth example of the first embodiment of the invention,

FIG. 13 is a partial view in cross section of the locking device from FIGS. 12A and 12B,

FIGS. 14A to 14C show diagrammatically a bimetal strip in various configurations,

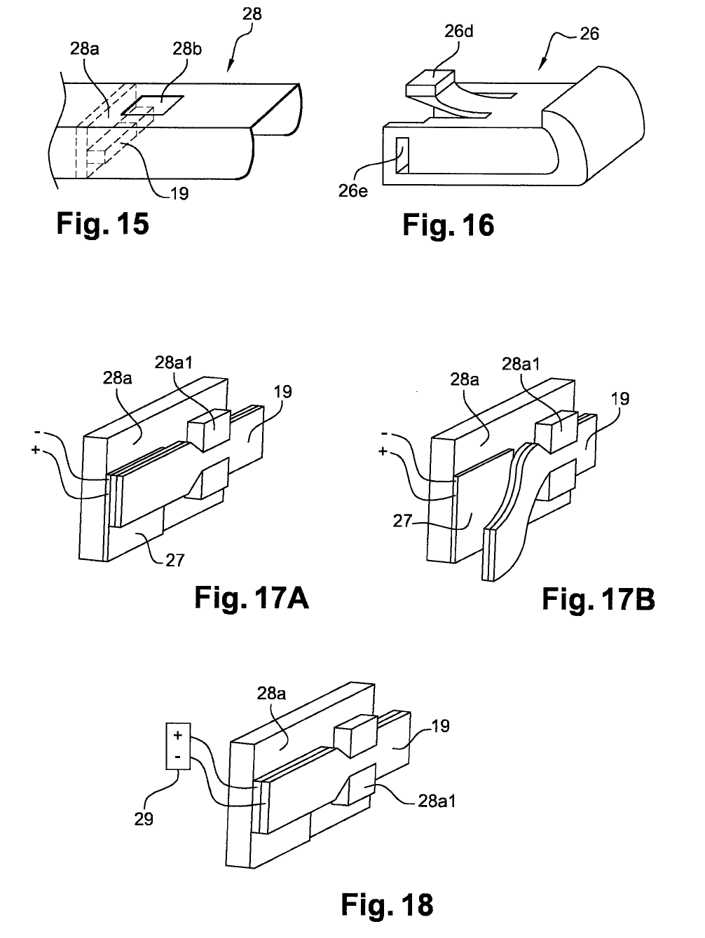

FIGS. 15 and 16 are diagrammatic partial views of a locking device according to a second embodiment of the invention,

FIG. 17A is a diagrammatic partial view of a locked position of a locking device according to a second embodiment of the invention,

FIG. 17B is a diagrammatic partial view of an unlocked position of a locking device according to a second embodiment of the invention,

FIG. 18 is a diagrammatic partial view of a locked position of a locking device according to a variant of the second embodiment of the invention,

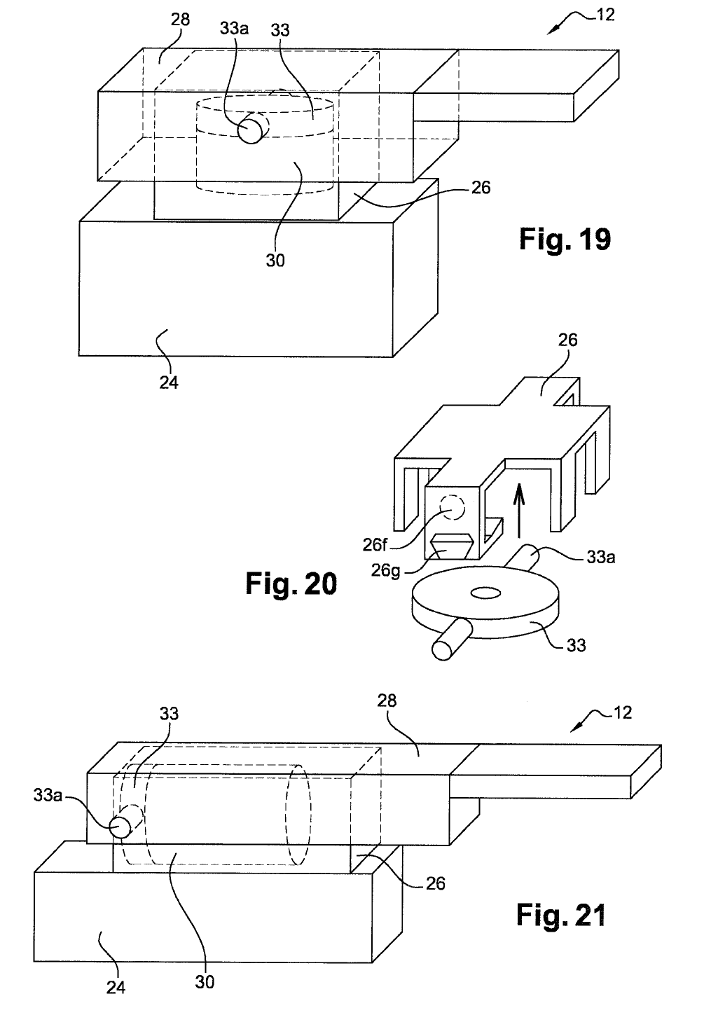

FIG. 19 is a diagrammatic view of a locking device according to a third embodiment of the invention,

FIG. 20 is a detail of the device from FIG. 19, and

FIG. 21 is a diagrammatic view of a locking device according to a variant of the third embodiment of the invention.

In the following description, the terms longitudinal and lateral refer to the orientation of the windshield wiper according to the invention. The longitudinal direction corresponds to the principal axis of the wiper along which it extends, while the lateral orientations correspond to straight line segments that are concurrent, i.e. that cross the longitudinal direction, in particular perpendicular to the longitudinal axis of the wiper in its rotation plane. For the longitudinal directions, the terms exterior and interior are understood relative to the point at which the wiper is fixed to a wiper arm, the term interior corresponding to the part where the arm and a half-wiper extend. Finally, the directions referred to as upper and lower correspond to orientations perpendicular to the rotation plane of the windshield wiper, the term lower containing the plane of the windshield.

Referring to FIGS. 1 to 21, elements that are identical or functionally equivalent are identified by identical reference numbers.

There is shown in FIG. 1 a windscreen wiper assembly, in particular for a motor vehicle windshield, this windshield wiper assembly comprising a longitudinal windshield wiper 10 and a wiper arm 12 that is partially shown and is intended to be driven by a motor to follow an angular to-and-fro movement enabling water and where applicable other unwanted elements covering the windshield to be evacuated.

Here the wiper 10 comprises a longitudinal cover member 14, a longitudinal wiper blade 16, generally of rubber, and at least one longitudinal spine 18 that stiffens the blade 16 in such a manner as to strengthen the application of that blade 16 to the windshield.

The cover member 14 of the wiper 10 includes an upper aerodynamic deflector 20 intended to improve the operation of the windshield wiper, the purpose of this deflector 20 being to strengthen the pressing of the wiper 10 onto the windshield and therefore to improve the overall aerodynamic performance.

The wiper 10 further comprises end-pieces or clips 22 for attaching the blade 16 and the spine 18 to the cover member 14, these clips 22 being situated at each of the longitudinal ends of the cover member 14.

Here the cover member 14 of the wiper is made in two independent parts that are disposed substantially end-to-end and separated from one another by an intermediate connector 24. This connector 24 is therefore inserted between the two parts of the cover member 14 and may comprise fluidic connection means of means for feeding windshield washer liquid from the connector 24 to pipes of the member 14.

For mounting it on the arm 12, the wiper 10 comprises an adapter 26 mounted on the connector 24 and allowing articulation of the wiper 10 relative to the arm 12. The articulation of the wiper 10 relative to the arm 12 is an articulation in accordance with a movement of rotation about a rotation axis Y perpendicular to the longitudinal axis of the wiper 10. The wiper 10 must in fact have at least one degree of freedom in rotation relative to the arm 12, and to be more specific relative to an end part 28 of the arm 12, to allow the wiper 10 to follow the curvature of the windshield.

Modern wipers being costly, it is desirable to prevent the theft of these wipers, in particular by locking the arm 12 to the wiper 10 in an immobilization zone I with a retention force G that is typically greater than 100 N (FIG. 2). For example, the arm-wiper connection may be locked when the driver is not present in the vehicle or when the ignition switch of the vehicle has not been operated and the arm-wiper connection to be unlocked when the driver is in the vehicle and/or the ignition switch of the vehicle has been operated.

The invention enables this objective to be achieved, by using electrical means able to drive a reversible movement of at least one locking element between a so-called unlocked position in which said at least one element no longer locks the wiper to the arm and a so-called locked position in which said at least one element locks the wiper to the arm.

An electromagnetic field may be used to lock the wiper to the arm, in particular with the aid of an electromagnet, which is a member producing a magnetic field when it is supplied with electricity. The theory underlying this first embodiment is shown in FIGS. 3, 4A and 4B, which represent an electromagnet 4.

A current generator 1, such as a battery, feeds a solenoid 2 with electrical current. A solenoid is a device constituted of an electrical wire wound regularly in a helix in such a manner as to form a long coil. Carrying a current, it produces a magnetic field B in its vicinity, and more particularly inside the helix, where this field is virtually uniform. The magnetic field lines drive the movement of a core 3 disposed in the interior of the coil 2. Thus, from a first end position of the core 3 (FIG. 4A), in which the core 3 is in a retracted position 2, for example because of a spring, not shown, the supply of current to the coil 2 will cause a movement of the core 3 toward the exterior of the coil 2, in the direction indicated by the arrow, as far as a second end position in which the core 3 is in a deployed position. The second end position of the core 3 is shown in FIG. 4B. The core 3 may be held in this second end position, in the absence of electrical current in the coil 2, with the aid of a permanent magnet (not shown). The core 3 can return to its first end position by reversing the direction of the current in the coil 2.

Accordingly, in a first embodiment, these two end positions of the core are used to define a locked position and an unlocked position of the arm and the wiper. In particular, the first end position defines an unlocked position of the arm and of the wiper and the second end position defines a locked position of the arm and of the wiper.

Four examples conforming to this first embodiment are described next. In these examples, the core 3 serves as a piston.

In a first example, the wiper is locked to the arm with the aid of two locking rods 5 secured to a member of the wiper for example of the connector 24, and substantially orthogonal to the core 3 of the electromagnet 4. The rods 5 are movable in translation with the aid of the core 3 between an unlocked position of the device and a locked position of the device in which the rods 5 each come to obstruct an opening 6 of the end part 28 of the arm, said end part 28 commonly being termed a yoke. In this example, the electromagnet 4 may be secured to the arm.

In an unlocked position, shown in FIG. 5A, the rods 5 are maintained in contact one against the other with the aid of springs 8. The core 3 is in its first end position (retracted position), described above and shown in FIG. 4A. The unlocked position therefore implies the flow of a current in the electromagnet 4, in such a manner as to produce a magnetic field that places the core 3 in its first end position. The longitudinal axis of the rods 5a is substantially orthogonal to that of the core 3. The rods 5 are provided on the side of the center of the connector 24 with an end 5a of rounded shape, for example of circular or oval section. The core 3 of the electromagnet 4 has a beveled end 31 able to be inserted during its movement toward it second end position (deployed position) between the ends 5a of the rods 5, the beveled shape making it possible to move the two ends 5a away from one another at the start of the movement of the core 3. The rods 5 are guided in translation by guide means 7. The return elements 8 may be disposed around the rods 5. The rods 5 are provided at the same end as the yoke 28 with an enlarged end 5b able to be inserted in an opening 6 of the yoke 28. Each rod 5 therefore comprises a central part 5c, an end 5a at a distance from the opening 6 associated with the rod 5 and an end 5b of greater section than the central part 5c and intended to be engaged in the opening 6. Each end 5c is of substantially identical section to the opening 6 in which it is engaged. Each opening 6 may have any type of contour, advantageously a circular contour.

FIG. 5B shows the locked position of the device. The core 3 is in its second end position, described above and shown in FIG. 4B. The movement of the core 3 out of the electromagnet 4 has driven the radial movement of the rods 5, the ends 5a of the rods 5 situated at the same end as the yoke 28 obstructing the openings 6 of the yoke 28, which locks the yoke 28 to the connector 24, the connector 24 no longer being able to move longitudinally relative to the yoke 28. The return elements 8 and the core 3 disposed between the rods 5 moreover prevent radial movement of the rods 5. In the locked position, the electromagnet 4 is not fed with electrical current, so as to place the core 3 in its second end position.

In this first example, the device enables securing (locking) of the arm to the wiper in the locked position and rotation of the wiper relative to the arm, for example about the axis Y in FIG. 1, in the unlocked position.

In a second example, there is used instead of the rods 5 a leaf spring 9 secured to a member of the wiper, for example the connector 24, that exerts a return force longitudinally relative to the electromagnet 4 and its core 3. The leaf spring 9 is disposed substantially orthogonally to the core 3. In an unlocked position, shown in FIG. 6A, the leaf spring 9 is in its curved position, at rest. The core 3 of the electromagnet 4 is connected to an actuator 13 movable in translation on rails 11. The core 3 is in its first end position, described above and shown in FIG. 4A. The unlocked position therefore implies the flow of a current in the electromagnet 4, so as to produce a magnetic field that places the core 3 in its first end position. The spring 9 is in its curved position, in which its ends 9a are not engaged in the openings 6 of the yoke 28.

The movement of the core 3 to its second end position will drive the actuator 13 in translation, which will deform the spring 9 into a deployed position in which the spring 9 is substantially straight and in which the ends 9a of the spring 9 are engaged in the openings 6 of the yoke 28 (FIG. 6B). The spring 9 is then immobilized longitudinally and radially by the actuator 13 and by a rear stop 15. In this locked position, the electromagnet 4 is not supplied with electric current, so as to place the core 3 in its second end position.

In this second example, the device enables securing (locking) of the arm to the wiper in the locked position and rotation of the wiper relative to the arm, for example about the axis Y in FIG. 1, in the unlocked position.

In a third example, the core 3 comprises a crenelated (toothed) end 32 meshing with a toothed shaft 17. The toothed shaft 17 passes through two elongate openings 6, for example of rectangular section, of the yoke 28 and comprises two elongate ends 17a each projecting from an opening 6.

In the unlocked position shown in FIG. 7A the core 3 is in its first end position, described above and shown in FIG. 4A. The unlocked position therefore implies the flow of a current in the electromagnet 4, so as to produce a magnetic field that places the core 3 in its first end position. In this unlocked position, the core 3 cooperates with the toothed shaft 17 so that the two ends 17a situated outside the yoke have substantially the same section as the openings 6.

The movement of the core 3 to its second end position will drive the toothed shaft 17 in rotation to the locked position (FIG. 7B). In that locked position each end 17a, because of its elongate shape and its rotation relative to the unlocked position, no longer coincides with its associated opening 6 and projects from the opening 6 on either side of the longer sides of the opening 6. Each end 17a therefore bears against the yoke 28, enabling locking of the shaft 17 to the yoke 28.

The meshing is preferably configured so that the passage of the core 3 from its first end position to its second end position drives a rotation of approximately 90° of the toothed shaft 17.

In this third example the device enables securing (locking) of the arm to the wiper in the locked position and rotation of the wiper relative to the arm, for example about the axis Y in FIG. 1, in the unlocked position.

In a variant of the first embodiment, the electromagnet 4 is replaced by an electromechanical card 4′. The electromechanical card 4′ enables the piston 3 to be moved by an electric current.

By analogy with FIGS. 4A and 4B, from a first end position of the piston 3 (FIG. 8A), in which the piston 3 is situated partly outside the card 4′, thanks to the supply of current to the card 4′. Interrupting the supply of electrical power to the electromechanical card 4′ will cause a movement of the piston 3 toward the outside of the card 4′, to a second end position. This second end position of the core 3 is shown in FIG. 8B.

The three examples conforming to this embodiment are shown in FIGS. 9A, 9B; 10A,10B and 11A,11B. They are identical to the three examples shown in FIGS. 5A, 5B; 6A, 6B and 7A, 7B, respectively, except that the electromagnet 4 has been replaced by the electromechanical card 4′. In these three examples, the device enables securing (locking) of the arm to the wiper in the locked position and rotation of the wiper relative to the arm, for example about the axis Y in FIG. 1, in the unlocked position.

In a fourth example of this first embodiment, it is the piston 3 itself that constitutes the locking element. In the unlocked position shown in FIG. 12A, the piston 3 is in its first end position, described above and shown in FIG. 4A. An adapter 26 secured to the wiper comprises a clipping system enabling securing of the arm 12 to the adapter 26. The adapter therefore comprises a lug 26a intended to be inserted in an opening of the arm 12 (FIG. 13). The lug 26a is disposed on a removable platform 26b that descends when the arm 12 presses on the lug 26a during the insertion of the arm 12 into the adapter 26, until the lug 26a lodges in the opening of the arm 12, which leads to securing of the arm 12 to the adapter 26. The arm 12 can subsequently be detached from the adapter 26 by lowering the platform 26b, for example manually, so as to disengage the lug 26a from the arm 12. The platform 26b is provided with a lower housing 26c, disposed under the lug 26a, in which the piston 3 will lodge when it reaches it second end position (FIG. 12B). When the piston 3 is lodged in the housing 26c, it is therefore no longer possible to lower the platform 26b to disengage the lug 26a from the opening of the arm 12: the piston 3 constitutes a bottom stop of the platform 26b and locking is therefore assured.

Alternatively, the electromagnet 4 may be replaced by an electromechanical card, as described above.

In this fourth example, the device enables securing (locking) of the arm to the wiper in the locked position.

In a second embodiment of the locking device according to the invention, the locking element is a bimetal strip. A bimetal strip is a component comprising two strips of different metals or alloys with different thermal expansions. The expansion of the two strips being different, the bimetal strip is deformed with variations of temperature. The strips, generally flexible, are welded, for example by cold rolling, or glued one against the other, in the lengthwise direction.

This principle is shown in FIGS. 14A to 14C. FIG. 14A shows a bimetal strip 19 at rest. The bimetal strip 19 comprises an upper layer 19a, for example of steel, and a lower layer 19b, for example of copper. An increase in temperature causes the steel 19a to expand more than the copper 19b and the bimetal strip 19 is deformed upward (FIG. 14B). A decrease of temperature causes the copper 19b to contract more than the steel 19a and the bimetal strip 19 is deformed downward (FIG. 14C).

The deformations and the forces developed can be calculated from parameters of each component and the temperature variation. The deviation of the bimetal element is given by the following equation:

$$δ = \frac{( V \cdot {L}^{2} \cdot Δ T )}{2 \cdot e}$$

in which:
δ designates the deviation of the bimetal element (m),
V designates the specific curvature (K⁻¹),
L designates the length of the bimetal element (m),
ΔT designates the temperature variation (K),
e designates the thickness of the bimetal element (m).

The specific curvature is given by the equation:

$$V = \frac{2}{3} \cdot \frac{{α}_{2} - {α}_{1}}{1 + \frac{{( {E}_{1} \cdot {e}_{1}^{2} - {E}_{2} \cdot {e}_{1}^{2} )}^{2}}{4 \cdot {E}_{1} \cdot {e}_{1} \cdot {E}_{2} \cdot {e}_{2} \cdot {e}^{2}}}$$

in which:
V designates the specific curvature (K⁻¹)
E₁ and E₂ designate the moduli of elasticity of the respective materials in the temperature range (Pa),
α₁ and α₂ designate the respective coefficients of thermal expansion of the materials (K⁻¹).
e=e₁+e₂ designates the thickness of the bimetal element (m),
e₁ and e₂ designate the thickness of the respective materials (m).

If E₁.e₁²−E₂.e₂²=0, the maximum value of V is reached, with the result that:

$$\frac{{e}_{1}}{{e}_{2}} = \sqrt{\frac{{E}_{2}}{{E}_{1}}}$$

This ratio enables deduction of the optimum dimensions of the bimetal element and the materials used to obtain the maximum deviations and forces.

In this case, the materials must be chosen according to:
their use in micro-fabrication,
their electrical conductivity, so as to be heated by the Joule effect,
their greater coefficient of thermal expansion.

Actually, the optimum ratio of the thickness of the materials for maximum force and maximum deviation is obtained from the Young's modulus of each material. Taking by way of example as materials aluminum, which is the most used material in micro-fabrication, and silicon, with respect to which aluminum has the greatest difference in terms of coefficient of thermal expansion:

$$\frac{{e}_{Al}}{{e}_{Si}} = \sqrt{\frac{{E}^{Si}}{{E}^{Al}}}$$

$${e}_{Al} = {e}_{Si} \sqrt{\frac{{E}^{Si}}{{E}^{Al}}}$$

$${e}_{Al} = 1.27 \cdot {e}_{Si}$$

The thickness of the bimetal element can therefore be determined.

In the unlocked position, the bimetal strip may be secured to the arm of the windshield wiper. As shown in FIG. 15, the bimetal strip 19 is disposed on a support 28a of the yoke 28 of the arm. The yoke 28 further comprises an opening intended to receive a clip 26d of the adapter 26 (FIG. 16). The adapter 26 comprises two lateral orifices 26e, each lateral orifice 26e receiving a longitudinal end of the bimetal strip 19. In the locked position, the bimetal strip 19 is therefore secured to the arm, via the support 28a, and also secured to the wiper, via the lateral orifices of the adapter 26.

One end of the bimetal strip 19 may be in thermal contact with a heating part 27, for example a heating element, which may be disposed on the support 28a of the yoke 28. In the locked position shown in FIG. 17A the heating part 27, which is secured to the support 28a with the aid of an attachment element 28a1 projecting from the support 28, is no longer supplied with electrical power. The heating part 27 therefore does not give off heat and the bimetal strip 19 is therefore not deformed. When the heating part 27 is supplied with electrical power it gives off heat. The end of the bimetal strip 19 in thermal contact with the heating part 27 will then be deformed and therefore disengaged from the orifice 26e of the adapter 26. The unlocked position is reached (FIG. 17B).

Alternatively, as shown in FIG. 18, the heating part may be replaced by direct heating of the bimetal strip 19 with the aid of an electrical power supply 29.

In this second embodiment, the device enables securing (locking) of the arm to the wiper in the locked position.

In a third embodiment, locking is produced with the aid of magnetization means secured to the arm or to the wiper and cooperating with means able to be magnetized and secured to the wiper or to the arm, respectively, and the magnetization means or the means able to be magnetized are rotatably mounted in the arm or the wiper to which they are secured. This embodiment is shown in FIGS. 19 to 21.

The locking device may therefore comprise an electromagnet 30 secured to the connector 24 and intended to magnetize a metal part 33 that is rotatably mounted in the adapter 26 with the aid of a rotation shaft 33a. The adapter 26 is secured to the yoke 28 of the arm 12 (FIG. 19). Locking is obtained by activating the electromagnet 30 that will magnetize the part 33. The plane of the magnetization surface of the electromagnet 30 and of the metal part 33 is substantially parallel to the plane of the arm 12.

The locking device may therefore be mounted vertically to obtain the configuration from FIG. 19. The metal part 33 is inserted in the adapter 26, each end of the shaft 33a being disposed in a housing 26f of the adapter (FIG. 20). The adapter 26 is then secured to the yoke 28 of the arm 12, for example clipped to it with the aid of an element 26g projecting from the adapter 26. The assembly and the locking of the arm 12 to the wiper are then produced by magnetization of the metal part 33 by the electromagnet 30. The presence of the rotation shaft 33 advantageously enables relative rotation of the arm 12 and the wiper.

Alternatively, as shown in FIG. 21, the metal part 33 and the magnetization surface of the electromagnet 30 are disposed substantially perpendicularly to the plane of the arm 12, which enables horizontal mounting of the locking device. The electromagnet 30 is secured to the connector 24, the magnetization surface of the electromagnet 30 being disposed perpendicularly to the upper surface of the connector 24. The metal part 33 is inserted in the adapter 26, each end of the shaft 33a being disposed in a housing 26f of the adapter (FIG. 20). The adapter 26 is then secured, for example clipped to the yoke 28 of the arm 12. The assembly and the locking of the arm 12 to the brush are then produced by magnetization of the metal part 33 by the electromagnet 30.

In this third embodiment, the device enables securing (locking) of the arm to the wiper in the locked position and rotation of the wiper relative to the arm, for example about the axis Y in FIG. 1, in the unlocked position.

1. A device for locking a windshield wiper to a drive arm, the device comprising
electrical means that drive a reversible movement of at least one locking element secured to the arm or to the wiper,
said at least one locking element moving relative to the arm or to the wiper to which the at least one locking element is secured between an unlocked position in which said at least one locking element is secured only to the arm or to the wiper and a locked position in which said at least one locking element is secured to both the arm and to the wiper.

2. The device as claimed in claim 1, wherein the electrical means are able to actuate in translation a piston, the movement of said piston driving movement of said at least one locking element.

3. The device as claimed in claim 2, wherein said piston is the core of an electromagnet, said core being movable in translation by the magnetic field produced by the electromagnet.

4. The device as claimed in claim 2, wherein said piston is part of a device enabling movement of the piston by an electric current.

5. The device as claimed in claim 2, wherein, in the unlocked position, said at least one locking element is secured to a connector of the wiper and wherein, in the locked position, said at least one locking element is secured to the connector and to an end part of the arm.

6. The device as claimed in claim 5, wherein said at least one locking element comprises at least one rod able to be engaged in the locking position in an opening of said end part and to be held at a distance from said opening in the unlocked position.

7. (canceled)

8. The device as claimed in claim 6, wherein said at least one rod is movable in translation in a direction substantially orthogonal to the direction of movement of the piston.

9. The device as claimed in claim 5, wherein said at least one locking element comprises a leaf spring of which at least one end is engaged in an opening of the end part of the arm in the locked position.

10.-14. (canceled)

15. The device as claimed in claim 5, wherein said at least one locking element comprises a toothed shaft driven in rotation by a toothed part of the piston.

16. (canceled)

17. The device as claimed in claim 1, wherein the piston is secured to the arm and wherein, the arm being mounted on and demounted from an element secured to the windshield wiper, the piston is movable between an unlocked position, in which unlocking is authorized, and a locked position, in which the piston forms a stop preventing demounting.

18. The device as claimed in claim 11, wherein the arm is mounted or demounted from the element secured to the windshield wiper with the aid of a clip the clip comprising a lug mounted on a removable platform, and wherein the platform is provided with a housing to receive the piston placed under the lug, so that the piston forms a stop for the platform when engaged in said housing in the locked position.

19. The device as claimed in claim 11, wherein the element secured to the windshield wiper is an adapter.

20. The device as claimed in claim 1, wherein said at least one locking element comprises a bimetal strip.

21. The device as claimed in claim 14, wherein the bimetal strip is deformable by a variation of temperature from a locked position in which it is secured to an end part of the arm and an adapter to an unlocked position in which it is secured only to the end part.

22. The device as claimed in claim 14, wherein the electrical means are adapted to heat the bimetal strip.

23. (canceled)

24. A windshield wiper, comprising
a locking device as claimed in claim 1.

25. A motor vehicle, comprising
a windshield wiper;
a drive arm;
a device for locking the wiper to the arm as claimed in claim 1;
means for activation of the locking; and
means for detection of the presence of a driver in the vehicle and/or the operation of an ignition switch in the vehicle,
the activation means being able to activate the locking in the event of detection by the detection means of the presence of a driver in the vehicle and/or of starting of the engine of the vehicle.

26.-29. (canceled)
